(19) United States
(12) Patent Application Publication
(10) Pub. No.: US 2014/0130017 A1
(43) Pub. Date: May 8, 2014

(54) TEST CASE SCREENING METHOD AND SYSTEM

(71) Applicant: Tencent Technology (Shenzhen) Company Limited, Shenzhen (CN)

(72) Inventors: Juhong Wang, Shenzhen (CN); Lin Yuan, Shenzhen (CN); Shuohao Ke, Shenzhen (CN); Xin Huang, Shenzhen (CN); Jinze Chen, Shenzhen (CN); Yichun Han, Shenzhen (CN)

(73) Assignee: Tencent Technology (Shenzhen) Company Limited, Shenzhen (CN)

(21) Appl. No.: 14/154,600

(22) Filed: Jan. 14, 2014

Related U.S. Application Data
(63) Continuation of application No. PCT/CN2013/072536, filed on Mar. 13, 2013.

(30) Foreign Application Priority Data
Mar. 28, 2012 (CN) 201210086547.9

(51) Int. Cl. G06F 11/36

(52) U.S. Cl. CPC G06F 11/3684
USPC 717/124

(57) ABSTRACT

A method of screening for test cases comprises the following steps: obtaining the number of times that a function node is triggered; calculating the weight of the function node according to the number of times that the function node is triggered; and screening for a test case relevant to the function node according to the weight of the function node. In the above manner, a test case relevant to a function node that is triggered many times in actual operation can be screened for. If the function node is triggered many times, it indicates that the function node is frequently used, and the function node that is frequently used is of great importance.

This application is a continuation application of PCT international application PCT/CN2013/072536, filed on Mar. 13, 2013, which claims the priority of Chinese Patent Application No. 201210086547.9, entitled “TEST CASE SCREENING METHOD AND SYSTEM”, filed with the Chinese Patent Office on Mar. 28, 2012, both of which are incorporated herein by reference in their entirety.

### FIELD

The present disclosure relates to the computer technology and in particular to a test case screening method and system.

### BACKGROUND

A software test is one of important phases throughout a software lifecycle, and a software system has to be tested repeatedly for a number of times before the software system has been checked and accepted and put into commission. A test on the software system is performed by executing test cases. Each test case generally includes a test object, a test environment, input data, test steps and an expected result. In a test process, the test environment is built as per the test case, the preset input data is input in the preset test steps, and an output result is checked against the expected result for match. Test cases covering all of functional nodes to be analyzed in the software system are typically used in each test on the software system.

The software system may be modified or updated for a number of times. The tests have to be performed on the software system in many times using all the test cases after each modification or update. In the foregoing solution, the test cases have not been screened and consequently may not be of high pertinence. Thus, there may be a repeated and redundant effort in the test process, thereby degrading the test efficiency.

### SUMMARY

In view of this, it is desirable to provide a test case screening method capable of improving the test efficiency.

A test case screening method includes the steps of:
obtaining the number of times each of functional nodes has been triggered;
calculating a weight of the functional node according to the number of times that the functional node has been triggered; and
screening test cases pertinent to the functional nodes according to the weights of the functional nodes.

In view of this, it is further desirable to provide a test case screening system capable of improving the test efficiency.

A test case screening system includes:
a trigger-times obtaining module adapted to obtain the numbers of times each of functional nodes has been triggered;
a weight calculating module adapted to calculate a weight of the functional node according to the number of times that the functional node has been triggered; and
a case screening module adapted to screen test cases pertinent to the functional nodes according to the weights of the functional nodes.

Moreover it is further desirable to provide a computer storage medium including computer executable instructions adapted to perform a test case screening method capable of improving the test efficiency.

One or more computer storage medium include computer executable instructions adapted to perform a test case screening method, and the method includes the steps of:
obtaining the numbers of times each of functional nodes has been triggered;
calculating a weight of the functional node according to the number of times the functional node has been triggered; and
screening test cases pertinent to the functional nodes according to the weights of the functional nodes.

In the foregoing test case screening method and system, after a software system has been in operation for a period of time, the numbers of times that the functional nodes have been triggered are retrieved, the weight of each functional node is calculated according to the number of times that the functional node have been triggered, and the test cases pertinent to the functional nodes are screened according to the weights of the functional nodes. The foregoing solution can screen out the test cases pertinent to the functional nodes which have been triggered for a large number of times in practical operation. The large number of times that a functional node has been triggered can indicate a high frequency that the functional node has been used, and the functional node used frequently also has a great importance. Thus, in the foregoing solution, the test cases pertinent to the functional nodes with a great importance can be screened out in practical operation, and the screened-out test cases are of high pertinence. Thus, a test can be performed with the screened-out test cases to thereby improve the test efficiency of the software system.

### BRIEF DESCRIPTION OF THE DRAWINGS

FIG. 1 is a schematic flow chart of a test case screening method in an embodiment; and

FIG. 2 is a schematic structural diagram of a test case screening system in an embodiment.

### DETAILED DESCRIPTION OF EMBODIMENTS

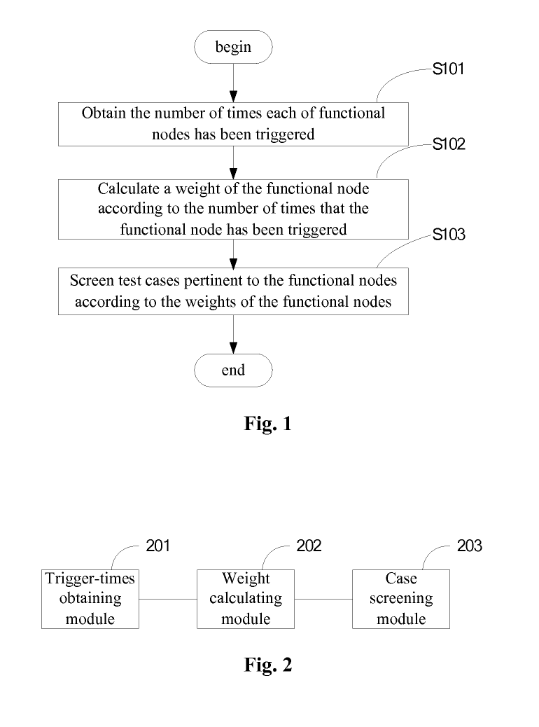

As illustrated in FIG. 1, in an embodiment, a test case screening method includes the following steps S101-S103.

The step S101 is to obtain the numbers of times each of functional nodes has been triggered.

In an embodiment, a statistic code may be added in advance to program codes related to the functional node. The statistic code among the program codes related to the functional node is also executed when the functional node is triggered, and the statistic code may write a log of the functional node being triggered into a specified file or database. Furthermore, the number of times that the functional node has been triggered may be retrieved from the specified file or database after a system has been in stable operation for a preset period.

The step S102 is to calculate a weight of each functional node according to the number of times that the functional node has been triggered.

In an embodiment, the weight of the functional node may be calculated as the ratio of the number of times that the functional node has been triggered to the total number of times that all functional nodes have been triggered.

Specifically, the weight of the functional node may be calculated in the formula of: the weight of the functional node=the number of times that a functional node has been triggered/the total number of times that all functional nodes have been triggered. That is, the weight of a functional node in the system is equal to the ratio of the number of times that the functional node has been triggered to the total number of times that all functional nodes in the system have been triggered.

The more the number of times that the functional node has been triggered, the higher the weight of the functional node calculated in the foregoing formula.

The step S103 is to screen test cases pertinent to the functional nodes according to the weights of the functional nodes.

In an embodiment, a preset number of functional nodes ranked higher by the weights may be retrieved, and test cases pertinent to the retrieved functional nodes may be selected.

Specifically, the functional nodes may be ranked in an order of descending weights, a first preset number of functional nodes may be selected, and the test cases pertinent to the first preset number of functional nodes may be selected in a case library.

The functional nodes ranked higher by the weights are important functional nodes. In this embodiment, the test cases pertinent to the functional nodes ranked higher by the weights are selected to thereby screen out the test cases with great importance and pertinence.

In another embodiment, the step S103 includes: calculating an average weight of the functional nodes, retrieving functional nodes with the weights above the average weight, and selecting test cases pertinent to the retrieved functional nodes.

Specifically, the average weight of the functional nodes may be calculated by dividing the sum of the weights of all the functional nodes by the total number of functional nodes. Specifically the sum of the weights of all the functional nodes may be 1. Furthermore, the functional nodes with the weights above the average weight are retrieved, and test cases pertinent to the retrieved functional nodes are selected in the case library.

The functional nodes with the weights above the average weight are also the important functional nodes, so the test cases of high importance may also be screened out in this embodiment.

In a further embodiment, in the step S103, the test cases pertinent to the functional nodes may be selected according to the weights of the functional nodes, so that the proportion of the test cases pertinent to each of the functional nodes to all the selected test cases is equal to the weight of the functional node. For example, the weights of a functional node 1, a functional node 2 and a functional node 3 are 5/10, 3/10 and 2/10 respectively. Then, the case library may be firstly searched for a part or all of test cases pertinent to the functional node 1, where assumed 500 test cases pertinent to the functional node 1 are retrieved from the case library. Since the ratio of the weights of the functional node 1, the functional node 2 and the functional node 3 is 5:3:2, the ratio of the numbers of selected test cases of the functional node 1, the functional node 2 and the functional node 3 is also 5:3:2. In this case, 300 test cases pertinent to the functional node 2 and 200 test cases pertinent to the functional node 3 may be further retrieved from the case library.

In this embodiment, the numbers of selected test cases of the respective functional nodes are assigned according to the weights of the functional nodes. In this way, more test cases is selected for the functional node with a higher weight, less test cases is selected for the functional node with a lower weight, and the numbers of selected test cases reasonably reflect the importance of the functional nodes pertinent thereto. Thus, the foregoing solution can select test cases covering a larger range of functional nodes and also can select more test cases for a functional node with a great importance. Consequently, the foregoing solution can screen out the test cases, the number of which is reasonably assigned according to the importance of the functional node, and a test can be performed with the test cases selected in the above method, thereby improving the test efficiency.

In an embodiment, the foregoing test case screening method further includes the step of retrieving the number of times that a user interface component associated with the functional node has been accessed.

In this embodiment, the step S102 may include: calculating the weight of the functional node according to the number of times that the functional node has been triggered and the number of times that the user interface component associated with the functional node has been accessed.

In an embodiment, the user interface component includes a page, a button, etc., for interaction with a user at the front end. An access to the user interface component at the front end can trigger the functional node at the back end associated with the user interface component. The correspondence relationship between the user interface component at the front end and the functional node at the back end is a one-to-many relationship or a many-to-many relationship.

Specifically, in an embodiment, a statistic code may be added to program codes of the user interface component associated with the functional node. When the user accesses the user interface component, the program codes of the user interface component and also the statistic code among the program codes are executed. The statistic code may write a log of the user interface component being accessed into the specified file or database. Furthermore, the number of times that the user interface component has been accessed may be retrieved from the specified file or database after the system has been in stable operation for the preset period.

Furthermore, in the step S102, a first ratio of the number of times that the functional node has been triggered to the total number of times that all functional nodes have been triggered may be calculated, a second ratio of the number of times that the user interface component associated with the functional node has been accessed to the total number of times that all user interface components have been accessed can be calculated, and the weight of the functional node can be selected as the average of the first weight and the second weight.

Specifically, in the step S102, the weight of the functional node may be calculated in the formula of: the weight of a functional node=(the number of times that the functional node has been triggered/the total number of times that all the functional nodes have been triggered+the number of times that the user interface component associated with the functional node has been accessed/the total number of times that all the user interface components have been accessed)/2. That is, the weight of a functional node in the system is equal to the average of the first ratio and the second ratio, where the first ratio is the ratio of the number of times that the functional node has been triggered to the total number of times that all the functional nodes in the system have been triggered, and the second ratio is the ratio of the number of times that the user interface component associated with the functional node has been accessed to the total number of times that all the user interface components in the system have been accessed.

In this embodiment, the step S103 of calculating the average weight of the functional nodes includes: calculating a third ratio of the sum of the weights of all the functional nodes to the total number of all the functional nodes, calculating a fourth ratio of the average number of times that all the user interface components have been accessed to the total number of times that all the user interface components have been accessed, and calculating the average weight of the functional nodes as the average of the third ratio and the fourth ratio.

In this embodiment, the weight of a functional node is calculated, according to the proportion of the number of times that the functional node has been triggered to the total number of times that all the functional nodes have been triggered and the proportion of the number of times that a user interface component associated with the functional node has been accessed to the total number of times that all the user interface components have been accessed. The more the number of times that the functional node has been triggered, or the more the number of times that the user interface component associated with the functional node has been accessed, the higher the weight of the functional node. In practical operation of the software system, a larger number of times that a functional node has been triggered or a larger number of times that a user interface component associated with the functional node has been accessed indicate a great importance of the functional node. In this embodiment, the high weight of a functional node has a great importance. Test cases of functional nodes with the great importance may be selected according to the weights of the functional nodes to select the test cases of higher pertinence. In this way, the test may be performed with the selected test cases, thereby improving the test efficiency.

In an embodiment, the foregoing method further includes the step of performing a test with the screened-out test cases.

Specifically as in the conventional automatic test method, input data of each of the test cases may be input to a software system in test steps, and a result output from the software system may be compared with expected output data for the test case. If they match, then the test case passes; otherwise, an error report may be output.

In this embodiment, the test cases of the functional nodes with the great importance are screened out, and a test is performed with the screened-out test cases, thereby improving the test efficiency of the software system.

As illustrated in FIG. 2, in an embodiment, a test case screening system includes a trigger-times obtaining module 201, a weight calculating module 202 and a case screening module 203.

The trigger-times obtaining module 201 is adapted to obtain the number of times each of functional nodes has been triggered.

In an embodiment, a statistic code may be added in advance to program codes related to the functional node. The statistic code among the program codes related to the functional node is also executed when the functional node is triggered, and the statistic code may write a log of the functional node being triggered into a specified file or database. Furthermore the trigger-times obtaining module 201 may retrieve the number of times that the functional node has been triggered from the specified file or database after a system has been in stable operation for a preset period.

The weight calculating module 202 is adapted to calculate a weight of each functional node according to the number of times that the functional node has been triggered.

In an embodiment, the weight calculating module 202 may calculate the weight of the functional node as the ratio of the number of times that the functional node has been triggered to the total number of times that all functional nodes have been triggered.

Specifically the weight calculating module 202 may calculate the weight of the functional node in the formula of: the weight of the functional node=the number of times that a functional node has been triggered/the total number of times that all functional nodes have been triggered. That is, the weight of a functional node in the system is equal to the ratio of the number of times that the functional node has been triggered to the total number of times that all the functional nodes in the system have been triggered.

The more the number of times that the functional node has been triggered, the higher the weight of the functional node calculated in the foregoing formula.

The case screening module 203 is adapted to screen test cases pertinent to the functional nodes according to the weights of the functional nodes.

In an embodiment, the case screening module 203 may retrieve a preset number of functional nodes ranked higher by the weights and select test cases pertinent to the retrieved functional nodes.

Specifically, the case screening module 203 may rank the functional nodes in an order of descending weights, select a first preset number of functional nodes and select test cases pertinent to the first preset number of functional nodes in a case library.

The functional nodes ranked higher by the weights are important functional nodes. In this embodiment, the test cases pertinent to the functional nodes ranked higher by the weights are selected to thereby screen out the test cases with great importance and pertinence.

In another embodiment, the weight calculating module 202 is further adapted to calculate the average weight of the functional nodes, and the case screening module 203 is adapted to retrieve functional nodes with the weights above the average weight and to select test cases pertinent to the retrieved functional nodes.

Specifically the weight calculating module 202 may calculate the average weight of the functional nodes by dividing the sum of the weights of all the functional nodes by the total number of functional nodes. Furthermore the case screening module 203 may retrieve the functional nodes with the weights above the average weight and select the test cases pertinent to the retrieved functional nodes in the case library.

The functional nodes with the weights above the average weight are also the important functional nodes, so the test cases of high importance may also be screened out in this embodiment.

In a further embodiment, the case screening module 203 may select the test cases pertinent to the functional nodes according to the weights of the functional nodes, so that the proportion of the test cases pertinent to each of the functional nodes to all the selected test cases is equal to the weight of the functional node. For example, the weights of a functional node 1, a functional node 2 and a functional node 3 are 5/10, 3/10 and 2/10 respectively. Then, the case library may be firstly searched for a part or all of test cases pertinent to the functional node 1, where assumed 500 test cases pertinent to the functional node 1 are retrieved from the case library. Since the ratio of the weights of the functional node 1, the functional node 2 and the functional node 3 is 5:3:2, the ratio of the numbers of selected test cases of the functional node 1, the functional node 2 and the functional node 3 is also 5:3:2. In this case, 300 test cases pertinent to the functional node 2 and 200 test cases pertinent to the functional node 3 may be further retrieved from the case library.

In this embodiment, the numbers of selected test cases of the respective functional nodes are assigned according to the weights of the functional nodes. In this way, more test cases is selected for the functional node with a higher weight, less test cases is selected for the functional node with a lower weight, and the numbers of selected test cases reasonably reflect the importance of the functional nodes pertinent thereto. Thus the foregoing solution can select test cases covering a larger range of functional nodes and also can select more test cases for a functional node with a great importance. Consequently, the foregoing solution can screen out the test cases, the number of which is reasonably assigned according to the importance of the functional node, and a test can be performed with the test cases selected in the above method, thereby improving the test efficiency.

In an embodiment, the trigger-times obtaining module 201 is further adapted to retrieve the number of times that a user interface component associated with the functional node has been accessed.

In this embodiment, the weight calculating module 202 is adapted to calculate the weight of the functional node according to the number of times that the functional node has been triggered and the number of times that the user interface component associated with the functional node has been accessed.

In an embodiment, the user interface component includes a page, a button, etc., for interaction with a user at the front end. An access to the user interface component at the front end can trigger the functional node at the back end associated with the user interface component. The correspondence relationship between the user interface component at the front end and the functional node at the back end is a one-to-many relationship or a many-to-many relationship.

Specifically, in an embodiment, a statistic code may be added to program codes of the user interface component associated with the functional node. When the user accesses the user interface component, the program codes of the user interface component and also the statistic code among the program codes are executed, and the statistic code may write a log of the user interface component being accessed into the specified file or database. Furthermore, the weight calculating module 202 may retrieve the number of times that the user interface component has been accessed from the specified file or database after the system has been in stable operation for the preset period.

Furthermore the weight calculating module 202 may calculate a first ratio of the number of times that the functional node has been triggered to the total number of times that all the functional nodes have been triggered, calculate a second ratio of the number of times that the user interface component associated with the functional node has been accessed to the total number of times that all user interface components have been accessed, and calculate the weight of the functional node as the average of the first weight and the second weight.

Specifically, the weight calculating module 202 may calculate the weight of the functional node in the formula of: the weight of a functional node=(the number of times that the functional node has been triggered/the total number of times that all the functional nodes have been triggered+the number of times that the user interface component associated with the functional node has been accessed/the total number of times that all the user interface components have been accessed)/2. That is, the weight of a functional node in the system is equal to the average of the first ratio and the second ratio, where the first ratio is the ratio of the number of times that the functional node has been triggered to the total number of times that all the functional nodes in the system have been triggered, and the second ratio is the ratio of the number of times that the user interface component associated with the functional node has been accessed to the total number of times that all the user interface components in the system have been accessed.

In this embodiment, the weight calculating module 202 can calculate a third ratio of the sum of the weights of all the functional nodes to the total number of all the functional nodes, calculate a fourth ratio of the average number of times that all the user interface components have been accessed to the total number of times that all the user interface components have been accessed, and calculate the average weight of the functional nodes as the average of the third ratio and the fourth ratio.

In this embodiment, the weight of a functional node is calculated, according to the proportion of the number of times that the functional node has been triggered to the total number of times that all the functional nodes have been triggered and the proportion of the number of times that a user interface component associated with the functional node has been accessed to the total number of times that all the user interface components have been accessed. The more the number of times that the functional node has been triggered, or the more the number of times that the user interface component associated with the functional node has been accessed, the higher weight of the functional node. In practical operation of the software system, a larger number of times that a functional node has been triggered or a larger number of times that a user interface component associated with the functional node has been accessed indicate a great importance of the functional node. In this embodiment, the high weight of a functional node has a great importance. Test cases of functional nodes with the great importance may be selected according to the weights of the functional nodes to select the test cases of higher pertinence. In this way, the test may be performed with the selected test cases, thereby improving the test efficiency.

In an embodiment, the foregoing test case screening system further includes a testing module (not illustrated) adapted to perform a test with the screened-out test cases.

Specifically as in the conventional automatic test method, the test module may input data of each of the test cases to a software system in test steps, and compare a result output from the software system with expected output data in the test case. If they match, then the test case passes; otherwise, the test module may output an error report.

In this embodiment, the test cases of the functional nodes with the great importance are screened out, and a test is performed with the screened-out test cases, thereby improving the test efficiency of the software system.

In the foregoing test case screening method and system, after the software system has been in operation for a period, the number of times that each functional node has been triggered are retrieved, the weight of each functional node is calculated according to the number of times that the functional node has been triggered, and the test cases pertinent to the functional nodes are screened according to the weights of the functional nodes. The foregoing solution can screen out the test cases pertinent to the functional nodes which have been triggered for a large number of times in practical operation, and a large number of times that a functional node has been triggered indicate that the functional node has been used frequently, and the functional node used frequently has a great importance. Thus the foregoing solution can screen out the test cases pertinent to the functional nodes with the great importance in practical operation, and the screened-out test cases are of high pertinence. In this way, a test may be performed with the screened-out test cases to thereby improve the test efficiency of the software system.

Those ordinarily skilled in the art can appreciate that all or a part of the flow in the method of the foregoing embodiment can be performed by computer program controlling relevant hardware, where the program can be stored in a computer readable storage medium, and the program can include the flow of the foregoing embodiment of the method upon being executed. Particularly the storage medium can be a magnetic disk, an optic disk, a Read Only Memory (ROM), a Random Access Memory (RAM), etc.

The foregoing embodiments are merely representative of several embodiments of the disclosure by way of a detailed description thereof but shall not be construed hereby to limit the scope of the disclosure. It shall be noted that those ordinarily skilled in the art can further make several modifications and variations thereto without departing from the spirit of the disclosure, and these modifications and variations shall come into the scope of the disclosure. Accordingly the scope of the disclosure shall be as defined in the appended claims.

1. A test case screening method, comprising the steps of:
obtaining the number of times each of functional nodes has been triggered;
calculating a weight of the functional node according to the number of times that the functional node has been triggered; and
screening test cases pertinent to the functional nodes according to the weights of the functional nodes.

2. The test case screening method according to claim 1, wherein the step of calculating a weight of the functional node according to the number of times that the functional node has been triggered comprises:
calculating the weight of the functional node as the ratio of the number of times that the functional node has been triggered to the total number of times that all functional nodes have been triggered.

3. The test case screening method according to claim 1, wherein the method further comprises:
retrieving the number of times that a user interface component associated with the functional node has been accessed; and
the step of calculating a weight of the functional node according to the number of times that the functional node has been triggered comprises:
calculating the weight of the functional node according to the number of times that the functional node has been triggered and the number of times that the user interface component associated with the functional node has been accessed.

4. The test case screening method according to claim 3, wherein the step of calculating the weight of the functional node according to the number of times that the functional node has been triggered and the number of times that the user interface component associated with the functional node has been accessed comprises:
calculating a first ratio of the number of times that the functional node has been triggered to the total number of times that all functional nodes have been triggered, calculating a second ratio of the number of times that the user interface component associated with the functional node has been accessed to the total number of times that all user interface components have been accessed, and calculating the weight of the functional node as an average of the first weight and the second weight.

5. The test case screening method according to claim 1, wherein the step of screening test cases pertinent to the functional nodes according to the weights of the functional nodes comprises:
retrieving a preset number of functional nodes ranked higher by the weights and selecting test cases pertinent to the retrieved functional nodes.

6. The test case screening method according to claim 1, wherein the step of screening test cases pertinent to the functional nodes according to the weights of the functional nodes comprises:
calculating an average weight of all functional nodes, retrieving functional nodes with the weights above the average weight, and selecting test cases pertinent to the retrieved functional nodes.

7. A test case screening system, comprising:
a trigger-times obtaining module adapted to obtain the number of times each of functional nodes has been triggered;
a weight calculating module adapted to calculate a weight of the functional node according to the number of times that the functional node has been triggered; and
a case screening module adapted to screen test cases pertinent to the functional nodes according to the weights of the functional nodes.

8. The test case screening system according to claim 7, wherein the weight calculating module is adapted to calculate the weight of the functional node as the ratio of the number of times that the functional node has been triggered to the total number of times that all functional nodes have been triggered.

9. The test case screening system according to claim 7, wherein the trigger-times obtaining module is further adapted to retrieve the number of times that a user interface component associated with the functional node has been accessed; and
the weight calculating module is adapted to calculate the weight of the functional node according to the number of times that the functional node has been triggered and the number of times that the user interface component associated with the functional node has been accessed.

10. The test case screening system according to claim 9, wherein the weight calculating module is adapted to calculate a first ratio of the number of times that the functional node has been triggered to the total number of times that all functional nodes have been triggered, to calculate a second ratio of the number of times that the user interface component associated with the functional node has been accessed to the total number of times that all user interface components have been accessed, and to calculate the weight of the functional node as an average of the first weight and the second weight.

11. The test case screening system according to claim 7, wherein the test case screening module is adapted to retrieve a preset number of functional nodes ranked higher by the weights and to select test cases pertinent to the retrieved functional nodes.

12. The test case screening system according to claim 7, wherein the test case screening module is adapted to calculate an average weight of all functional nodes, to retrieve functional nodes with the weights above the average weight and to select test cases pertinent to the retrieved functional nodes.

13. A computer storage mediums, comprising computer executable instructions adapted to perform a test case screening method comprising:
obtaining the number of times each of functional nodes has been triggered;
calculating a weight of the functional node according to the number of times that the functional node has been triggered; and
screening test cases pertinent to the functional nodes according to the weights of the functional nodes.

14. The test case screening method according to claim 13, wherein the step of calculating a weight of the functional node according to the number of times that the functional node has been triggered comprises:
calculating the weight of the functional node as the ratio of the number of times that the functional node has been triggered to the total number of times that all functional nodes have been triggered.

15. The test case screening method according to claim 13, wherein the method further comprises:
retrieving the number of times that a user interface component associated with the functional node has been accessed; and
the step of calculating a weight of the functional node according to the number of times that the functional node has been triggered comprises:
calculating the weight of the functional node according to the number of times that the functional node has been triggered and the number of times that the user interface component associated with the functional node has been accessed.

16. The test case screening method according to claim 15, wherein the step of calculating a weight of the functional node according to the number of times that the functional node has been triggered and the number of times that the user interface component associated with the functional node has been accessed comprises:
calculating a first ratio of the number of times that the functional node has been triggered to the total number of times that all functional nodes have been triggered, calculating a second ratio of the number of times that the user interface component associated with the functional node has been accessed to the total number of times that all user interface components have been accessed, and calculating the weight of the functional node as an average of the first weight and the second weight.

17. The test case screening method according to claim 13, wherein the step of screening test cases pertinent to the functional nodes according to the weights of the functional nodes comprises:
retrieving a preset number of functional nodes ranked higher by the weights and selecting test cases pertinent to the retrieved functional nodes.

18. The test case screening method according to claim 13, wherein the step of screening test cases pertinent to the functional nodes according to the weights of the functional nodes comprises:
calculating an average weight of all functional nodes, retrieving functional nodes with the weights above the average weight, and selecting test cases pertinent to the retrieved functional nodes.
